(19) United States
(12) Patent Application Publication
(10) Pub. No.: US 2005/0227202 A1
(43) Pub. Date: Oct. 13, 2005

(54) Surgical instrument

(76) Inventor: Ernst Fuchs, Thalwil (CH)

Correspondence Address: Edwin D Schindler, Five Hirsch Avenue, PO Box 966, Coram, NY, 11727-0966, US

(21) Appl. No.: 10/519,772

(22) PCT Filed: Apr. 16, 2003
(86) PCT No.: PCT/DE03/01284

§ 371 Date: Dec. 24, 2004

(30) Foreign Application Priority Data
Jun. 27, 2002 (DE) 102 28 692.2

(51) Int. Cl. A61C 3/00; A61C 8/00

(52) U.S. Cl. 433/141; 433/173

(57) ABSTRACT

A surgical instrument for preparing implant beds in a lower jaw of a patient, which includes a drilling element with a spinous configuration and a handle fixed to the drilling element. The drilling element has a truncated cone having an outer surface line which forms a maximum angle of several degrees with the axis of the truncated cone, the outer surface of which is smooth. The handle is positioned at an angle in relation to the axis of the truncated cone.

The invention relates to a surgical instrument for preparing implant beds in the lower jaw and a method for producing the bed by means of a drilling element having a spinous shape, and a handle affixed thereon.

Prosthetic teeth are generally fixed to implant posts, which are anchored in a suitable implant bed in the patient's jaw. In the case of an implantation in the lower jaw, this bed is usually produced in that the bone at the place intended for the implantation is removed stage by stage by means of drills of increasing diameter. Hereby, the dimensions of the biggest drill in this series determine the diameter and length of the implant to be inserted. Finally, implants with a force fit or a screw thread are inserted into the bed produced. This method according to the prior art leads to useful results in the case of implants in regions of the lower jaw that have bone substance that is sufficient to receive the intended implant and of sufficient quality.

Because of the anatomy of the lower jaw of many patients, or a weakening of the jaw, for example as a result of atrophy, however, implantation according to the above-described method is subject to limitations. In such cases, the existing bone substances does not permit stable anchoring of implant posts of sufficient length without the use of further measures. There is therefore the need for suitable surgical instruments and methods that lead to a better quality of preparation of the implant bed than is possible by drilling according to the method of the prior art.

The invention is based on the object of providing means for preparing an implantation bed in the lower jaw, and a method for preparing the bed that effects a local improvement of the bone quality and/or of the local anatomy, and therefore a stable anchoring of the implants, in particular also in the case of problematic bone substance. The solution according to the invention is furthermore also characterised in that the proposed instruments are easy to handle and permit a very atraumatic invasion, the proposed method ensures complete healing of the implantation point in a short time and has a high success rate.

According to the invention, this object with respect to the surgical element is solved in that
the drilling element comprises a first truncated cone
   whose outer surface line encloses an angle of at most several degrees with the axis of the truncated cone,
   and whose outer surface line is designed so as to be smooth
and the handle is arranged at an angle to the axis of the aforementioned truncated cone,
   and, from the point of view of the method, by a method comprising the following operations:
a) determination of the direction and depth of the implantation with a pilot borehole by means of a first spiral drill
b) boring the corticalis (overlying bones) to a diameter required for carrying out the succeeding or a plurality of succeeding operations by means of a further spiral drill of larger diameter
c) widening the opening present in the spongiosa (filling bones) by means of the aforementioned surgical instrument
d) repetition of operations b) and c), if required, using an instrument whose first truncated cone, however, has a larger diameter that the instrument used previously.

To produce an implant bed, according to the proposed method, first a pilot borehole is introduced into the lower jaw.

This borehole determines the direction and depth of the intended implant. It is carried out by means of a small-diameter spiral drill, which is known per se, runs at high speed and has internal cooling. In a subsequent operation, an extension of the borehole takes place in the region of the hard overlying bone of the lower jaw, the corticalis, by means of a further spiral drill of larger diameter. This boring is limited entirely to the hard overlying bone, the diameter of the drill be chosen such that the opening in the jaw receives a diameter required for carrying out the subsequent or a plurality of subsequent operations. Seen overall, only a small amount of bone tissue is removed through the required bores.

The further preparation of the implant bed takes place with a surgical instrument according to the present invention. This instrument comprises a spinous drilling element, and a handle fixed thereto, the drilling element essentially consisting of a truncated cone with a very small opening angle and a smoothly shaped circumferential surface.

It should first be stated that a widening of the corticalis of the lower jaw is regarded as impossible by specialists, since the corticalis of the lower jaw is several times (5-10×) thicker than that of the upper jaw, where such work is common for preparing the insert. The present invention contradicts that, since—with the use of the instrument according to the invention—it permits the same work also to be carried out in the lower jaw.

It is important that the spine encloses an angle with the handle. It expressly does not comprise instruments in which the spine and handle point in the same direction, even in the case when the intermediate portion has a crank bend. The instrument must rather permit a vertical access to the lower jaw for introducing the implant, even in the case of the back teeth. For this purpose, the angled shape is essential. For preparing the implant bed, the proposed surgical instrument is introduced in advance, with the top surface of the truncated cone first, into the opening in the patient's lower jaw produced by the above-described process steps. The instrument used has a diameter of the top surface of the truncated cone which permits penetration through the enlarged borehole in the corticalis as far as the adjacent spongiosa. With a further introduction of the instrument, because of the conical design of the drilling element the bore is enlarged, the adjacent bone tissue being forced radially outwards. The design of the cone with a low conical angle and its smooth circumferential surface permit manual introduction of the instrument without great application of force. It is essential according to the invention that the handle of the proposed instrument is arranged at an angle to the axis of the truncated cone. By this means, during working with the instrument, an optimum position of the hand enclosing the handle and of the bore element is ensured relative to the opening in the lower jaw. Furthermore, by successive change of the direction of the instrument, that is to say its penetration section or axial inclination, an enlargement and also an uplifting of loosened segments are achieved.

By this handling, not only is the diameter in the spongiosa but also the axial inclination, i.e. the direction influenced simultaneously with the stretching. Here it is preferred to carry out an orientation in the direction of the bone deficit, both buccally and labially.

The widening process is generally repeated with further instruments of the same design, whose truncated cone, however, in each case has a top surface of larger diameter than the one used previously. Each of these operations leads to the bone tissue in the region of the implant being increasingly compressed.

As has been found in practice, the bone tissue retains this higher density even after termination of the healing process. The implant bed, by virtue of the proposed treatment, retains in an advantageous manner a much greater stability than the beds produced according to conventional methods by boring. From the local improvement of the bone quality, there also results a further important advantage, which consists in the fact that, by this means, implants in regions of the jaw become possible, which could not be carried out without preparation because of inadequate bone quality.

Furthermore, the production of the implant bed and the application of the instrument according to the present proposal, for the patient, represent an invasion with a comparatively low traumatic effect. The proposed method also achieves a healing of the implant position in a short time and a high success rate.

In an advantageous further development of the instrument according to the present invention, the drilling element comprises at least one further truncated cone, which is coaxially contiguous with the first truncated cone.

The top surface of the further truncated cone faces the base surface of the previous truncated cone and has a larger diameter than the base surface of the preceding truncated cone.

Instruments of this design permit in one operation the application of truncated cones with increasing diameters for widening the implant bed. In particular, by means of the further truncated cone, the inlet into the implant bore can be enlarged to such an extent that its diameter corresponds to the top surface diameter of the truncated cone of the instrument subsequently used.

The instrument subsequently used can thereby, in an advantageous manner, be applied much more easily, since it is precisely centred by the countersinking of the implant bore.

In an embodiment of the instrument tip, two variants are proposed in the scope of the present invention, wherein the first truncated cone is terminated in the region of its top surface by a surface that is rotationally symmetrical with respect to the cone axis. The two variants differ in that, in the first variant, the aforementioned surface is convex in design while, in the second variant, this surface has a concave form and forms a comparatively sharp cutting edge with the circumferential surface of the truncated cone.

Instruments having a design of the instrument tip according to the first variant are usually used if the aim in preparing the implant bed is essentially a compression of the bone tissue lying at the side of the bed.

The design of the instrument according to variant two, on the other hand, permits an accumulation of bone tissue at the base of the implant bore. This accumulation is obtained in that, with the introduction of instruments of this design into the implant bore because of the sharply formed edge between the aforementioned concavely shaped surface and the cone surface, bone tissue is removed from the walls of the bore. In the process, the removed tissue collections in the depression of the concavely designed surface and is finally compacted at the base of the borehole.

With an instrument according to variant two, the bone quality can thus be improved both in the region of the side walls of the implant bed and in the region of its base. The advantageous consequence of this is a particularly stable implant bed, which provides the implants with a very firm grip and brings good results even with an inferior bone quality.

Special importance in the case of the present invention is attached to the arrangement of the handle. As already mentioned, the handle of the instrument according to the invention is arranged at an angle to the axis of the truncated cone/truncated cones. In the scope of the present invention, in particular, angles of approx. 70 degrees, approx. 80 degrees, approx. 90 degrees or approx. 100 degrees are provided. The respective instrument is advantageously used if implants in the region of molars, of premolars or of anterior or canine teeth are to be made. Here, the instruments with a
handle angled by 70 degrees are used for the molars, position 6 or 7,
handle angled by 80 degrees are used for the premolars,
and a handle angled by 90 degrees are used in each case for the anterior teeth or canines.

In a preferred further development of the proposed surgical instrument, the angle between the handle and axis of the first truncated cone is designed so as to be adjustable. This design allows the position of the handle to be adapted in each case optimally to the respective implant location that is present. By this means, in an advantageous manner, different implant locations, such as the region of the molars, the premolars or the anterior or canine teeth, can be covered with one and the same instrument. The angle of 70, 80 or 90 degrees that is in each case optimum for these respective applications is easily set on the instrument at the beginning of the implantation. The number of different instruments, and thereby the space necessary for keeping them is thereby advantageously reduced.

In the design of the handle itself, according to the present invention, a solution is preferred in which the handle is detachably fixed on the drilling element. Here, it is recommended that the device for fixing be designed such that it permits engagement and disengagement of the handle. The device, in an advantageous manner, also leads to a reduction of the space required for keeping the instruments.

For preparing the implant bed, the widening operation is usually carried out in a plurality of steps According to the invention, it is therefore provided to provide instruments with essentially the same design but different diameters of the truncated cones. Correspondingly, in the case of instruments with an adjustable angle between the handle and truncated cone axis, for widening, a set of preferably 5 instruments is available, in the case of instruments with a fixed angle between the handle and truncated cone axis, on the other hand, a set of preferably 5 instruments is provided for each given angle. Herein, the instruments of a set form a series of graded diameters of corresponding truncated cones, the respective succeeding instrument, in this series, having a top-surface diameter of the first truncated cone, which is smaller than/equal to the base surface diameter of the last truncated cone of the respective preceding instrument in this series.

The instruments of the proposed sets thus completely cover all diameters that are required from the first to the last widening operation.

In the preparation of the implant bed, it is necessary that the surgeon carrying out the operation can recognise at any time how far the instrument used for widening has been introduced into the implant borehole. In a preferred embodiment of the instrument according to the present invention marks are therefore produced on the circumferential surfaces of the truncated cones which indicate the distance to the instrument tip. For example, a single ring characterises a first distance, a group of two rings characterises a second distance and a group of three rings characterises a third distance. The type of marking here is carried out in the same way on all instruments of each set, so that a clear idea can be obtained from the marking to the distance to the instrument tip.

As already indicated, the present invention also covers a method for bone-conserving production of an implant bed in the lower jaw, using spiral drills with internal cooling and at least one surgical instrument according to the present invention.

The individual process steps have already been described in the context of the description of the surgical instrument according to the invention.

An essential feature of the present method is the repeated widening of the implant opening in the spongiosa by means of the proposed surgical instrument. Herein, according to a feature of the invention, a further process operation is provided in which, in the region of the implant opening, a vertical osteotomy can be carried out distally or mesially upwards. The purpose of this surgical measure is to create a predetermined fracture point in the bone shell, which break open during widening of the opening. It leads to the bone shell being locally displaced slightly outwards in the course of preparation of the implant bed, so that the implantation opening can be widened to the necessary diameter. In the course of the healing process, the incision in the bone shell fills first with callous tissue, which however is reinforced by progressive mineralization to form bone tissue again.

The above-described process operation is provided in particular if the available anatomy of the lower jaw does not permit adequate widening of the implant bed. In the sense of implantology, it leads to a local improvement of the anatomy and thus also permits stable anchoring of implants in anatomically problematic cases.

Further details, features and advantages of the invention can be taken from the following part of the description, in which the surgical instrument according to the invention is explained with reference to a drawing, wherein

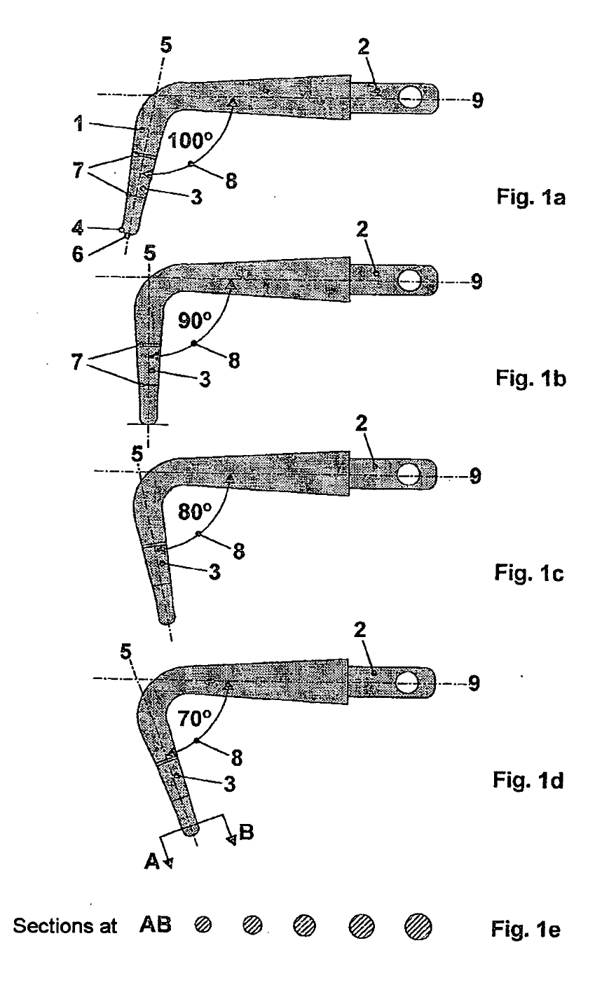

FIGS. 1a-1d show variants of the instrument for preparing the implant bed

FIG. 1e shows the diameter at the instrument tip of 5 instruments forming a set

FIGS. 1a-1d are based on variants of the surgical instrument. The head of the instrument is shown in each case in side view.

It comprises in each case a spinous drilling element 1 and a device 2 for detachable fixing of a handle that is not shown. In the present embodiment, the drilling element 1 consists in each case of a truncated cone 3 with a very small opening angle and a smooth circumferential surface. The instrument tip 4 is formed by a surface 6, which is designed to be rotationally symmetrical about an axis 5 of the truncated cone 3 and has a convex curvature. The reference character 7 indicates markings on the circumferential surface of the truncated cone 3, which indicates the distance to the tip 4 of the instrument.

In the case of the surgical instrument according to the present invention, the handle is arranged at the angle 8 to the axis 5 of the truncated cone 3.

As given in FIGS. 1a-1d, in particular angles 8 of approx. 100 degrees, approx. 90 degrees, approx. 80 degrees or approx. 70 degrees are provided between the axis 9 of the fixing device and the axis 5 of the truncated cone 3. The instrument with this design is advantageously used if implants in the region of molars, of premolars or of anterior or canine teeth are to be made. By this means an optimum position of the hand enclosing the handle and of the bore element is ensured relative to the implant opening in the lower jaw.

Instruments of the described type with convex tips 4 are usually used if a compaction of the bone tissue adjacent to the bone tissue is sought. For preparing the implant bed, the proposed surgical instrument is introduced in advance, with the instrument tip 4 cone first, into the opening (not shown) in the patient's lower jaw which has been produced by drilling. By moderate hand pressure on the instrument, the borehole is widened by virtue of the conical form of the truncated cone 3, the adjacent bone tissue being pressed radially outwards.

Widening of the implant bed is usually carried out in a plurality of steps According to the invention, it is therefore provided to provide instruments with essentially the same design with different diameters of the truncated cones 3. For each of the instrument types shown in FIGS. 1a-1d, there correspondingly exist a set of preferably 5 instruments whose tips 4 have the cross-sections shown in FIG. 1e. The illustrated cross-sections each lie in that region of the instrument that is indicated in FIG. 1d by the section line AB. As has been found in practice, the bone tissue retains the higher density obtained by enlargement of the implant bed even after termination of the healing process, and therefore ensures that the implants have a very tight grip.

1-11. (canceled)

12. A surgical instrument for preparing implant beds in a lower jaw of a patient, comprising:
a drilling element having a truncated cone with an outer surface line that is smooth and encloses an angle of no more than several degrees with an axis of said truncated cone; and,
a handle at an angle to said axis of said truncated cone.

13. The surgical instrument for preparing implant beds in a lower jaw of a patient according to claim 12, wherein said drilling element further comprises:
an additional truncated cone coaxially contiguous with said truncated cone, said additional truncated cone having a top surface that faces a base surface of said truncated cone with said top surface of said additional truncated cone having a larger diameter than a diameter of said base surface of said truncated cone.

14. The surgical instrument for preparing implant beds in a lower jaw of a patient according to claim 12, wherein said truncated cone terminates in a region of its top surface by an additional surface that is rotationally symmetrical relative to said axis of said truncated cone and is concave and forms a comparatively sharp cutting edge with a circumferential surface of said truncated cone.

15. The surgical instrument for preparing implant beds in a lower jaw of a patient according to claim 12, wherein said truncated cone terminates in a region of its top surface by an additional surface that is rotationally symmetrical relative to said axis of said truncated cone and convex.

16. The surgical instrument for preparing implant beds in a lower jaw of a patient according to claim 12, wherein said angle of said handle to said axis of said truncated cone is approximately 70°.

17. The surgical instrument for preparing implant beds in a lower jaw of a patient according to claim 12, wherein said angle of said handle to said axis of said truncated cone is approximately 80°.

18. The surgical instrument for preparing implant beds in a lower jaw of a patient according to claim 12, wherein said angle of said handle to said axis of said truncated cone is approximately 90°.

19. The surgical instrument for preparing implant beds in a lower jaw of a patient according to claim 12, wherein said angle of said handle relative to said axis of said truncated cone is approximately 100°.

20. The surgical instrument for preparing implant beds in a lower jaw of a patient according to claim 12, further comprising means for adjusting said angle of said handle relative to said axis of said truncated cone.

21. The surgical instrument for preparing implant beds in a lower jaw of a patient according to claim 12, wherein said handle is detachably fixed to said drilling element.

22. The surgical instrument for preparing implant beds in a lower jaw of a patient according to claim 12, further comprising markings on a circumferential surface of said truncated cone for indicating distance to an end of said surgical instrument that lies in close proximity of a top surface of said truncated cone.

23. A kit of surgical instruments, comprising:
a plurality of surgical instruments with each surgical instrument of said kit of surgical instruments including:
a drilling element having a truncated cone with an outer surface line that is smooth and encloses an angle of no more than several degrees with an axis of said truncated cone; and,
a handle at an angle to said axis of said truncated cone,
said plurality of surgical instruments forming a sequence of graded diameters of said truncated cone as to each said surgical instrument of said plurality of surgical instruments with each immediately succeeding said surgical instrument in said sequence having a top surface diameter of said truncated cone that is smaller than, or equal to, a base surface diameter of an immediately preceding said surgical instrument in said sequence.

24. The kit of surgical instruments according to claim 23, wherein at least one said surgical instrument of said plurality of surgical instruments includes means for adjusting said angle of said handle relative to said axis of said truncated cone.

25. The kit of surgical instruments according to claim 23, wherein each said surgical instrument of said plurality of surgical instruments has a fixed and predetermined angle between said angle of said handle relative to said axis of said truncated cone, with each said fixed and predetermined angle being graded as a sequence within said plurality of predetermined surgical instruments.

26. The kit of surgical instruments according to claim 25, wherein said plurality of surgical instruments comprises at least four said surgical instruments with a first said surgical instrument having said angle of said handle relative to said axis of said truncated cone of approximately 70°, a second said surgical instrument having said angle of approximately 80°, a third said surgical instrument having said angle of approximately 90° and a fourth said surgical instrument having said angle of approximately 100°, said at least four surgical instruments comprising at least a portion of said sequence.

27. A method for bone-conserving production of an implant bed in a lower jaw of a patient using spiral drills with internal cooling utilizing a surgical instrument comprising:
a drilling element having a truncated cone with an outer surface line that is smooth and encloses an angle of no more than several degrees with an axis of said truncated cone; and,
a handle at an angle to said axis of said truncated cone, said method comprising the steps of:
determining a direction and depth of an implantation with a pilot borehole via a first spiral drill;
boring the patient's corticalis via a second spiral drill of larger diameter than a diameter said first spiral drill; and,
widening an opening present in the patient's spongiosa via at least one said surgical instrument.

28. The method for bone-conserving production of an implant bed in a lower jaw of a patient according to claim 27, further comprising the step of:
repeating said boring step and said widening step using an additional said surgical instrument having a truncated cone of a larger diameter than said surgical instrument previously utilized.

29. The method for bone-conserving production of an implant bed in a lower jaw of a patient according to claim 28, further comprising the step of:
carrying out a vertical osteotomy distally or mesially upwards prior to said widening step of said repeating step.

30. The method for bone-conserving production of an implant bed in a lower jaw of a patient according to claim 27, further comprising the step of:
carrying out a vertical osteotomy distally or mesially upwards prior to said widening step.

31. The method for bone-conserving production of an implant bed in a lower jaw of a patient according to claim 27, wherein for an implantation in a region of a patient's molars, positions 6 or 7, said surgical instrument has said handle at said angle to said axis of said truncated cone through 70°, for an implantation in a region of a patient's premolars, said surgical instrument has said handle at said angle to said axis of said truncated cone of through 80°, and for an implantation in a region of a patient's anterior teeth or incisors, said surgical instrument has said handle at said angle to said axis of said truncated cone through 90°.
